(19) United States
(12) Patent Application Publication
(10) Pub. No.: US 2014/0136704 A1
(43) Pub. Date: May 15, 2014

(54) METHOD AND SYSTEM FOR REGISTRATION OR LOGIN

(71) Applicant: TENCENT TECHNOLOGY (SHENZHEN) COMPANY LIMITED, Shenzhen (CN)

(72) Inventors: Yu YANG, Shenzhen (CN); Yiping CHEN, Shenzhen (CN); Tingting AN, Shenzhen (CN); Rongjun FENG, Shenzhen (CN); Zhiyong LAI, Shenzhen (CN)

(73) Assignee: TENCENT TECHNOLOGY (SHENZHEN) COMPANY LIMITED, Shenzhen (CN)

(21) Appl. No.: 14/161,929

(22) Filed: Jan. 23, 2014

Related U.S. Application Data
(63) Continuation of application No. PCT/CN2012/079020, filed on Jul. 23, 2012.

(30) Foreign Application Priority Data
Aug. 3, 2011 (CN) 201110220837.3

(51) Int. Cl. H04L 29/08

(52) U.S. Cl. CPC H04L 67/02
USPC 709/225

(57) ABSTRACT

The present disclosure, pertaining to the field of Internet technologies, discloses a method and system for registration or login. The method includes: providing, by a server of a source website, a registration page having a verification link of a third-party website; upon receiving a trigger of the verification link of the third-party website from a user, outputting, by a server of the third-party website, a login page of the third-party website; receiving, by the server of the third-party website, login information input by a user on the third-party website, and verifying the login information; when the login information is successfully verified by the server of the third-party website, returning personal information of the user to the server of the source website; and acquiring, by the server of the source website, the personal information of the user, and correspondingly filling the personal information into registration information on the registration page of the source website. According to the present disclosure, during registration over a third-party website, the amount of information to be input during the website registration process is reduced, and the registration efficiency is improved.

This application is a continuation of International Application No. PCT/CN2012/079020, filed on Jul. 23, 2012, which claims priority to Chinese Patent Application No. 201110220837.3, filed before Chinese Patent Office on Aug. 3, 2011 and entitled “METHOD AND SYSTEM FOR REGISTRATION OR LOGIN OVER THIRD-PARTY WEBSITE”, both of which are incorporated herein by reference in their entireties.

### TECHNICAL FIELD

The present disclosure relates to the Internet field, and in particular, to a method and system for registration or login.

### BACKGROUND

Various websites on the Internet provide a variety of customized and specialized services for users. To use a service provided by a website, a user generally needs to complete registration on the website.

An existing website registration process is as follows:

A user firstly enters a registration page of a website; then, following the instructions or prompts on the registration page, the user needs to input some mandatory information, which is typically marked by an asterisk (*), for example, user name, password, email address, and the like; and furthermore, the user may also input some optional information, for example, real name, nationality, birth date, interest, hobby, and the like. After the user confirms the inputs, the website generally sends an activation email to the email address input during the registration. The website registration process is completed after the user receives the activation email in his or her email box, and clicks to access the activation address provided in the activation email.

With the existing website registration solution, when registering on different websites, the user needs to repeatedly input information data multiple times. In such a complex registration process, the user may abandon the registration due to tediousness and troublesomeness. This results in churning of users. Meanwhile, since too much information needs to be input, the user generally ignores or wildly and randomly fills the optional information input boxes. This results that the website fails to acquire complete knowledge of the personal information of the user, and thus fails to specifically provide customized services for the user.

### SUMMARY

To simplify a registration process, embodiments of the present disclosure provide a method and system for registration. The method includes:

providing, by a server of a source website, a registration page having a verification link of a third-party website;

upon receiving a trigger of the verification link of the third-party website from a user, outputting, by a server of the third-party website, a login page of the third-party website;

receiving, by the server of the third-party website, login information input by a user on the third-party website, and verifying the login information;

when the login information is successfully verified by the server of the third-party website, returning, by the server of the third-party website, personal information of the user to the server of the source website; and

acquiring, by the server of the source website, the personal information of the user, and correspondingly filling the personal information into registration information on the registration page of the source website.

The returning, by the server of the third-party website, personal information of the user to the server of the source website includes:

outputting, by the server of the third-party website, the personal information input by the user on the third-party website for the user to select;

receiving, by the server of the third-party website, the personal information selected by the user that is authorized to the server of the source website; and

returning, by the server of the third-party website, the personal information selected by the user that is authorized to the server of the source website to the server of the source website.

The outputting, by the server of the third-party website, the personal information input by the user on the third-party website for the user to select includes:

outputting, by the server of the third-party website, an authorization page, and options “Allow source website to use” and “Not allow source website to use” corresponding to each piece of the personal information for the user to select, where the authorization page includes the personal information input by the user on the third-party website.

After the correspondingly filling, by the server of the source website, the personal information into registration information on the registration page of the source website, the method further includes:

randomly generating, by the server of the source website, a password as an initial password for the user to log in to the source website; or using, by the server of the source website, a password input by the user as an initial password for the user to log in to the source website.

The third-party website includes an open platform website providing an application programming interface (API) for other websites.

The registration page having a verification link of a third-party website includes a basic option of a registration process.

The system includes: a server of a source website and a server of a third-party website.

The server of the source website includes: a first outputting module, configured to provide a registration page having a verification link of the third-party website.

The server of the third-party website includes: a second outputting module, configured to output a login page of the third-party website upon receiving from a user a trigger of the verification link of the third-party website output by a user to the outputting module.

The server of the third-party website further includes: a verifying module, configured to receive login information input by a user on the third-party website, and verify the login information.

The server of the third-party website further includes: a returning module, configured to return personal information of the user to the server of the source website when the login information is successfully verified by the server of the third-party website.

The server of the source website further includes: a registering module, configured to acquire the personal information of the user, and correspondingly fill the personal information into registration information on the registration page of the source website.

The returning module includes:

an outputting unit, configured to output the personal information input by the user on the third-party website for the user to select;

a receiving unit, configured to receive the personal information selected by the user that is authorized to the server of the source website; and

a returning unit, configured to return the personal information selected by the user that is authorized to the server of the source website to the server of the source website.

The outputting module is specifically configured to:

output an authorization page, and options “Allow source website to use” and “Not allow source website to use” corresponding to each piece of the personal information for the user to select, where the authorization page includes the personal information input by the user on the third-party website.

The server of the source website further includes:

a password generating module, configured to: after the server of the source website correspondingly fills the personal information into registration information on the registration page of the source website, randomly generate a password as an initial password for the user to log in to the source website; or use a password input by the user as an initial password for the user to log in to the source website.

The third-party website includes an open platform website providing an API for other websites.

The registration page having a verification link of a third-party website includes a basic option of a registration process.

Embodiments of the present disclosure provide a method and system for login. The method includes:

providing, by a server of a source website, a login page having a verification link of a third-party website;

upon receiving a trigger of the verification link of the third-party website from a user, outputting, by a server of the third-party website, a login page of the third-party website;

receiving, by the server of the third-party website, login information input by a user on the third-party website, and verifying the login information;

when the login information is successfully verified by the server of the third-party website, returning personal information of the user to the server of the source website; and

acquiring, by the server of the source website, the personal information of the user, and completing login according to the personal information of the user.

Prior to performing the preceding steps, the method further includes:

judging, by the server of the source website according to the personal information of the user, whether the user is a registered user of the source website;

if the user is a registered user of the source website, generating, by the server of the source website, a session key, displaying login status, and completing login;

otherwise, performing a subsequent step.

The judging, by the server of the source website according to the personal information of the user, whether the user is a registered user of the source website includes:

judging, by the server of the source website, whether a user name of the registered user comprises an email address of the user; if true, determining, by the server of the source website, that the user is a registered user of the source website; and otherwise, determining, by the server of the source website, that the user is not a registered user of the source website.

The third-party website includes an open platform website providing an API for other websites.

The system includes: a server of a source website and a server of a third-party website.

The server of the source website includes: a first outputting module, configured to provide a login page having a verification link of the third-party website.

The server of the third-party website includes: a second outputting module, configured to output a login page of the third-party website upon receiving from a user a trigger of the verification link of the third-party website output by an user to the outputting module.

The server of the third-party website further includes: a verifying module, configured to receive login information input by a user on the third-party website, and verify the login information.

The server of the third-party website further includes: a returning module, configured to return personal information of the user to the server of the source website when the login information is successfully verified by the server of the third-party website.

The server of the source website further includes: a login module, configured to acquire the personal information of the user, and complete login according to the personal information of the user.

The server of the source website includes: a judging module, configured to: prior to login, judging whether the user is a registered user of the source website; if the user is a registered user of the source website, generate a session key, display login status, and complete login; and otherwise, perform a subsequent step.

The judging module includes:

a judging unit, configured to: judge whether a user name of the registered user comprises an email address of the user; if true, determine that the user is a registered user of the source website; and otherwise, determine that the user is not a registered user of the source website.

The third-party website includes an open platform website providing an API for other websites.

The technical solutions provided in the embodiments of the present disclosure achieve the following beneficial effects:

During registration on a website, by using an interface provided by a third-party website, authorized personal information of a user is acquired from the third-party website, and the acquired personal information is filled into registration information on a registration page. This reduces the amount of information to be input during a registration process, and improves registration efficiency. In addition, the registration information comes from the third-party website having high credibility, thereby improving reliability of the registration information.

During website login, authorized personal information of a user is acquired over a third-party website, and whether the user is a user of a source website is judged according to the acquired personal information. If the user is a user of a source website, a session key is generated, login status is displayed, and the user does not need to memorize a plurality of passwords.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art can derive other accompanying drawings from these accompanying drawings without any creative efforts.

FIG. 1 is a flowchart of a method for registration according to an embodiment of the present disclosure;

FIG. 2 is a flowchart of a method for registration according to an embodiment of the present disclosure;

FIG. 3 is a schematic structural diagram of an authorization page according to an embodiment of the present disclosure; and

FIG. 4 is a flowchart of a method for login according to an embodiment of the present disclosure;

FIG. 5 is a flowchart of a method for login according to an embodiment of the present disclosure;

FIG. 6 is a schematic diagram of a system for registration according to an embodiment of the present disclosure; and

FIG. 7 is a schematic diagram of a system for registration according to an embodiment of the present disclosure.

### DETAILED DESCRIPTION

To make the objectives, technical solutions, and advantages of the present disclosure clearer, the embodiments of the present disclosure are described in detail below with reference to the accompanying drawings.

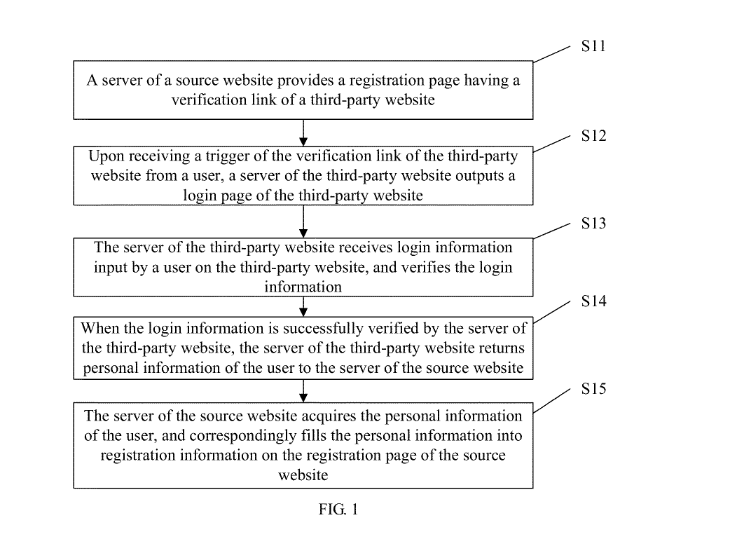

Referring to FIG. 1, this embodiment provides a method for registration, including:

S11: providing, by a server of a source website, a registration page having a verification link of a third-party website;

S12: upon receiving a trigger of the verification link of the third-party website from a user, outputting, by a server of the third-party website, a login page of the third-party website;

S13: receiving, by the server of the third-party website, login information input by a user on the third-party website, and verifying the login information;

S14: when the login information is successfully verified by the server of the third-party website, returning, by the server of the third-party website, personal information of the user to the server of the source website; and

S15: acquiring, by the server of the source website, the personal information of the user, and correspondingly filling the personal information into registration information on the registration page of the source website.

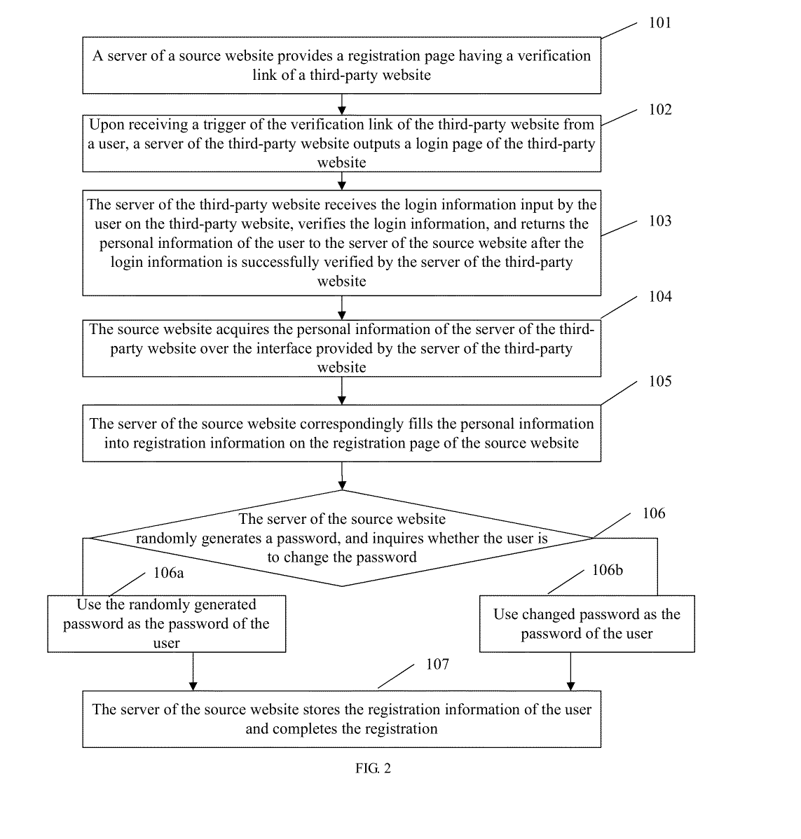

Referring to FIG. 2, the above-mentioned method is further described with reference to a specific embodiment.

101: A server of a source website provides a registration page having a verification link of a third-party website.

In this embodiment, the verification link of the third-party website is set on the registration page of the source website to extract the personal information of the user on the third-party website, thereby simplifying the registration process. The source website refers to a portal website where the user can register on or log in to the source website, for example, a video website or a shopping website, which is not limited in this embodiment. The third-party website refers a website not deployed by the owner of the source website but by another company or individual based on personal requirement or other reasons, which is used to enhance the functions of the source website. The third-party website includes an open platform website providing an API for other websites. In this embodiment, the third-party website is an open platform for providing an API for the source website and authorizes the source website to acquire partial information data of the user over the API. The third-party website generally has high credibility which imposes a higher security requirement on the registered account. If the user registers an account on the third-party website, the email address input by the user must be real and valid. For example, the third-party website may be Google, Facebook, Twitter and the like, which is not limited in this embodiment. In this embodiment, the user may access the source website over a terminal, such as a PC, a mobile phone, or other handheld devices, which is not limited in this embodiment. During specific implementation, the user opens the link address of the source website, and the server of the source website outputs an access page on the terminal for the user to browse. When the user accesses the source website, the server of the source website may directly output a registration page having the verification link of the third-party website such that the user continues the access after registration on the website; or may output a registration page having the verification link of the third-party website when the user clicks a registration request. This embodiment sets no limitation on the specific implementation.

In this embodiment, a plurality of verification links of the third-party websites may be set on the registration page for the user to select a third-party website to facilitate the registration. The verification link for account verification on the third-party website may be displayed, for example, in a manner of button, i.e., setting a button for the verification link of the third-party website on the registration page of the source website. This embodiment sets no limitation on the specific display manner of the verification link.

Optionally, a verification link button may be directly set instead of setting a verification link of the third-party website on the source website. When the user clicks the verification link button, a plurality of verification links are output; and/or an input window is set, on which the user may manually input a link address of the third-party website.

Assuredly, in this embodiment, the registration page may also include an option of the basic registration process. When the user selects this option, the existing registration page is output, and the user may perform the registration according to the existing registration manner.

102: Upon receiving a trigger of the verification link of the third-party website from a user, a server of the third-party website outputs a login page of the third-party website.

In this embodiment, according to settings on the source website, after the user triggers the verification link, different interfaces are output, and the user may select the third-party website or manually input the web address of the third-party website. Upon receiving the trigger of the verification link of the third-party website from the user, the server of the third-party website outputs a login page of the third-party website. 103: The server of the third-party website receives the login information input by the user on the third-party website, verifies the login information, and returns the personal information of the user to the server of the source website after the login information is successfully verified by the server of the third-party website.

Specifically, after the server of the third-party website outputs the login page, the user inputs the login information on the third-party website, i.e., a third-party account of the user on the third-party website. Subsequently, the server of the third-party website verifies the login information, and returns the personal information of the user to the server of the source website after successful verification.

Preferably, the returning, by the server of the third-party website, personal information of the user to the server of the source website includes:

outputting, by the server of the third-party website, the personal information input by the user on the third-party website for the user to select;

receiving, by the server of the third-party website, the personal information selected by the user that is authorized to the server of the source website; and returning, by the server of the third-party website, the personal information selected by the user that is authorized to the server of the source website to the server of the source website.

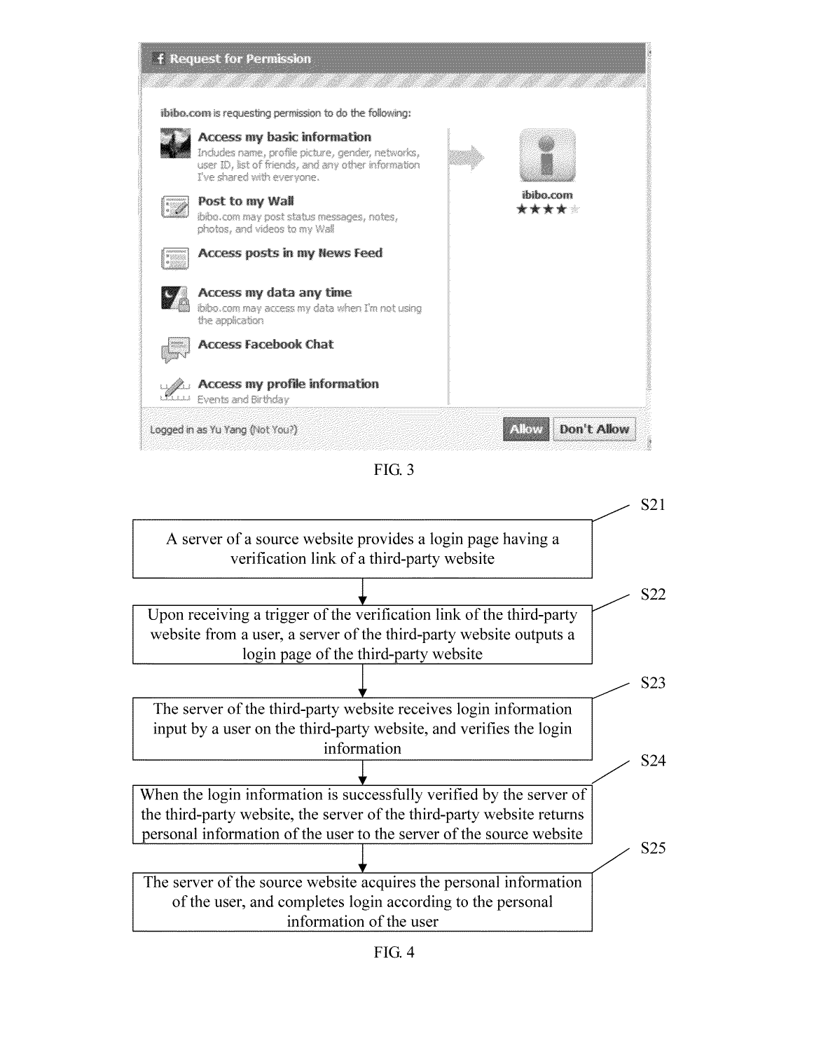

In this step, after the login information of the user is successfully verified by the server of the third-party website, personal information of users stored locally may be displayed for the user to select to whether to authorize the same to the source website. FIG. 3 illustrates an authorization page using Facebook as a third-party website. On the authorization page, two options “Allow source website to use” and “Not allow source website to use” may be further set. The user may select whether to allow the source website to use all or part of the personal information data on the third-party website. The outputting, by the server of the third-party website, the personal information input by the user on the third-party website for the user to select includes: outputting, by the server of the third-party website, an authorization page, and options “Allow source website to use” and “Not allow source website to use” corresponding to each piece of the personal information for the user to select, where the authorization page includes the personal information input by the user on the third-party website. When the user authorizes the source website to use part of the personal information on the third-party website, the third-party website returns the corresponding verification information to the source website. It should be noted that, after the user is successfully verified by the server of the third-party website, the server of the third-party website may directly return the personal information of the user to the server of the source website. However, for security of the personal information of the user, the server of the third-party website does not directly return the personal information of the user to the server of the source website, but returns verification of the personal information authorized for the source website to use to the server of the source website, such that the server of the source website further acquires the personal information of the user according to the verification information.

104: The source website acquires the personal information of the server of the third-party website over the interface provided by the server of the third-party website.

Specifically, the server of the source website may directly receive the authorized personal information of the user returned by the server of the third-party website, or acquire the authorized personal information of the user from the server of the third-party website over the interface provided by the server of the third-party website according to the verification information returned by the server of the third-party website. This embodiment sets no limitation on the specific implementation.

The authorized personal information includes such information as email address of the user, and may further include one or a plurality of pieces of such information of the user as age, gender, region, and career, which is not limited in this embodiment.

105: The server of the source website correspondingly fills the personal information into registration information on the registration page of the source website.

In this embodiment, according to the content to be filled on the registration page, the server of the source website correspondingly fills the acquired personal information of the user, such as age, gender, identity number, and email address, into the registration information. The source website may use the email address in the acquired personal information as a user name and fill the same into the registration information.

106: The server of the source website randomly generates a password, and inquires whether the user is to change the password.

In this step, to reduce input operations for the user, the user is not required to actively set a password. Instead, during registration according to the personal information acquired from the server of the third-party website, the server of the source website randomly generates a password and uses the same as an initial password for login to the source website; or the server of the source website uses the received password input by the user as an initial password for the user to log in to the source website. Specifically, the server of the source website generates an initial password for the user, and outputs a prompt interface of the initial password. The prompt interface of the initial password is used for inquiring whether the user is to change the initial password. Upon receiving selection information indicating that the user is not to change the initial password, the server of the source website uses the randomly generated initial password as the password of the user; and upon receiving selection information indicating that the user is to change the initial password, the server of the source website uses a changed password as the password of the user. This embodiment sets no limitation on the above-mentioned password setting.

106a: If the password is not to be changed, the randomly generated password is used as the password of the user, and step 107 is performed.

106b: If the password is to be changed, the changed password s used as the password of the user, and step 107 is performed.

107: The server of the source website stores the registration information of the user and completes the registration.

The source website stores such information as the web address of the third-party website that is bound, in addition to user name, password, and other registration information. The user may be bound to one or a plurality of third-party websites. The storage format is listed in Table 1.

TABLE 1

| | | | |
|---|---|---|---|
| User | Password | Other Registration | Bound Third-Party |
| Name | (stored in a database in | Information | Website Information |
| | an encryption manner) | | |

Furthermore, after completion of the registration, the user may log in to the website by using the method provided in an embodiment, or by using the login method disclosed in the prior art. To be specific, after entering the login interface of the website, the user inputs the user name and password set during the registration, and submits the user name and password to the system; the system verifies the user name and password input by the user; and if the user name and password are consistent with those input by the user during the registration, the verification is successful; and otherwise, the verification fails, and the user is not allow to log in to the website.

According to this embodiment, during registration on a website, by using an interface provided by a third-party website, authorized personal information of a user is acquired from the third-party website, and the acquired personal information is filled into registration information on a registration page. This reduces the amount of information to be input during a registration process, and improves registration efficiency. In addition, the registration information comes from the third-party website having high credibility, thereby improving reliability of the registration information.

Referring to FIG. 4, this embodiment provides a method for registration, including:

S21: providing, by a server of a source website, a login page having a verification link of a third-party website;

S22: upon receiving a trigger of the verification link of the third-party website from a user, outputting, by a server of the third-party website, a login page of the third-party website;

S23: receiving, by the server of the third-party website, login information input by a user on the third-party website, and verifying the login information;

S24: when the login information is successfully verified by the server of the third-party website, returning, by the server of the third-party website, personal information of the user to the server of the source website; and

S25: acquiring, by the server of the source website, the personal information of the user, and completing login according to the personal information of the user.

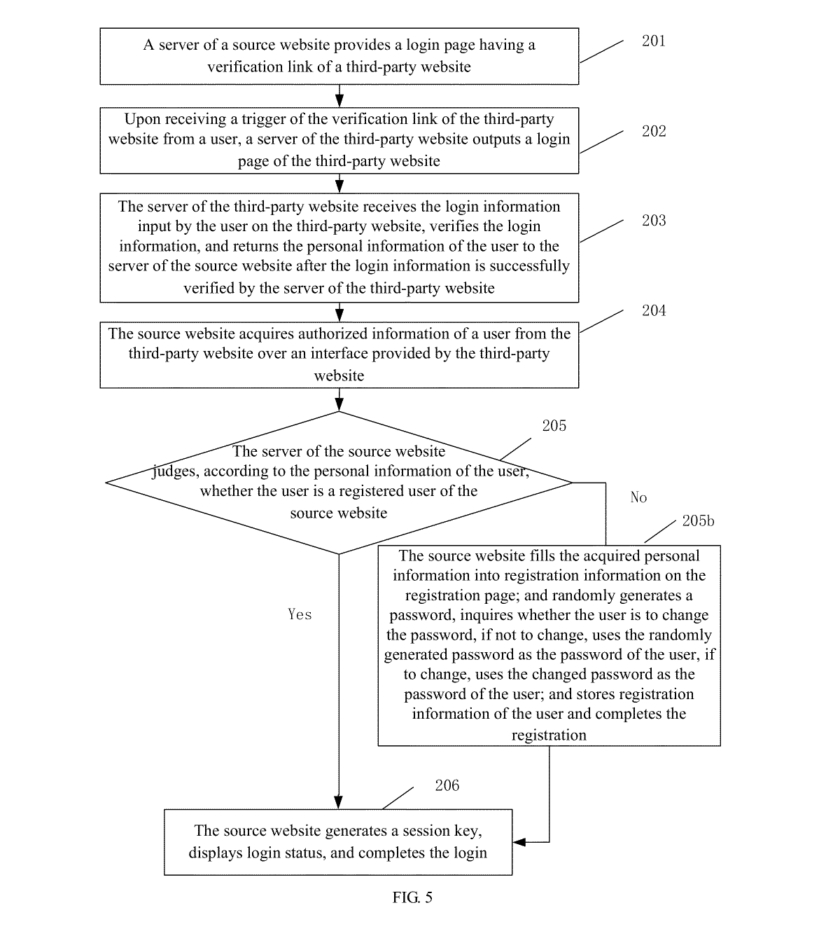

Referring to FIG. 5, the above-mentioned method is further described with reference to a specific embodiment.

201: A server of a source website provides a login page having a verification link of a third-party website.

For settings of the verification link, reference may be made to the description in above embodiment, which is not described herein any further.

202: Upon receiving a trigger of the verification link of the third-party website from a user, a server of the third-party website outputs a login page of the third-party website.

Furthermore, after the user triggers the verification link, the user, upon clicking the verification link, may directly skip to the third-party website according to the settings of the source website if only one third-party website is bound to the user during registration. When a plurality of third-party websites are bound to the user during registration, the user may allow one therefrom, and skip to the third-party website selected by the user. If the user does not perform registration according to the method described in an embodiment, the user may manually input the web address of the third-party website, and skip to the third-party website.

203: The server of the third-party website receives the login information input by the user on the third-party website, verifies the login information, and returns the personal information of the user to the server of the source website after the login information is successfully verified by the server of the third-party website.

The implementation of this step is the same as that of step 103, which is not described herein any further.

204: The source website acquires authorized information of a user from the third-party website over an interface provided by the third-party website.

The implementation of this step is the same as that of step 104, which is not described herein any further.

205: The server of the source website judges, according to the personal information of the user, whether the user is a registered user of the source website.

Specifically, the server of the source website judges whether a user name of the registered user includes an email address of the user; if true, the server of the source website determines that the user is a registered user of the source website; and otherwise, the server of the source website determines that the user is not a registered user of the source website.

In this embodiment, preferably, during registration of the user on the source website, the email address of the user is used as the user name for registration. Since different users have different email addresses, the case where the same user name identifies different users. Therefore, after the personal information of the user is acquired, preferably, whether the user is a registered user is judged according to the email address in the personal information of the user. Assuredly, such judgment may also be made according to other information in the personal information of the user, which is not limited in this embodiment.

205a: If the user is a registered user of the source website, step 206 is performed.

In this embodiment, if the user is a registered user of the source website, a login operation is further performed, details of which may be referred to step 206.

205b: If the user is not a registered user of the source website, the source website completes the registration by using steps 105-107, and performs step 206.

If the user is not a registered user of the source website, the user may complete the registration by using the method described in an embodiment and become a registered user of the source website; alternatively, the user may also complete the registration by using the method disclosed in the background art, and become a registered user of the source website. This embodiment sets no limitation on the specific method for the user to perform registration.

206: The source website generates a session key, displays login status, and completes the login.

According to this embodiment, during website login, authorized personal information of a user is acquired over a third-party website, and whether the user is a user of a source website is judged according to the acquired personal information. If the user is a user of a source website, a session key is generated, login status is displayed, and the user does not need to memorize a plurality of passwords. In addition, if a non-registered user is found, registration can be performed according to a simplified registration process, a session key is generated again, and login status is displayed. This saves registration time for the user, and the user does not need to memorize a plurality of passwords.

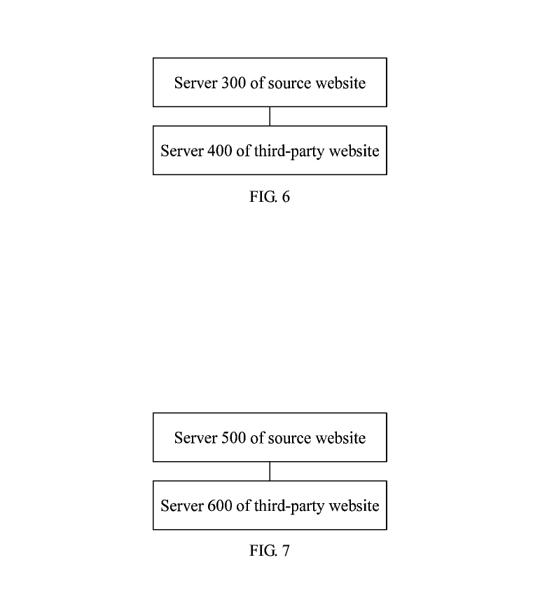

Referring to FIG. 6, this embodiment provides a system for registration. The system includes a server 300 of a source website and a server 400 of a third-party website.

The server 300 of the source website includes: a first outputting module, configured to provide a registration page having a verification link of the third-party website.

The server 400 of the third-party website includes: a second outputting module, configured to output a login page of the third-party website upon receiving from a user a trigger of the verification link of the third-party website output by the first outputting module.

The server 400 of the third-party website further includes: a verifying module, configured to receive login information input by a user on the third-party website, and verify the login information.

The server 400 of the third-party website further includes: a returning module, configured to return personal information of the user to the server of the source website when the login information is successfully verified by the server of the third-party website.

The server 300 of the source website further includes: a registering module, configured to acquire the personal information of the user, and correspondingly fill the personal information into registration information on the registration page of the source website.

The returning module includes:

an outputting unit, configured to output the personal information input by the user on the third-party website for the user to select;

a receiving unit, configured to receive the personal information selected by the user that is authorized to the server of the source website; and

a returning unit, configured to return the personal information selected by the user that is authorized to the server of the source website to the server of the source website.

The outputting module is specifically configured to:

output an authorization page, and options “Allow source website to use” and “Not allow source website to use” corresponding to each piece of the personal information for the user to select, where the authorization page includes the personal information input by the user on the third-party website.

Furthermore, the server 300 of the source website further includes:

a password generating module, configured to: after the server of the source website correspondingly fills the personal information into registration information on the registration page of the source website, randomly generate a password as an initial password for the user to log in to the source website, or use a password input by the user as an initial password for the user to log in to the source website.

In this embodiment, the third-party website includes an open platform website providing an API for other websites.

Optionally, the registration page having a verification link of a third-party website includes a basic option of a registration process.

The system provided in this embodiment is based on the same inventive concept as the source website in method embodiment. Therefore, the detailed implementation can refer to the description of the method embodiments of the present disclosure, which is not described herein any further.

According to this embodiment, during registration on a website, by using an interface provided by a third-party website, authorized personal information of a user is acquired from the third-party website, and the acquired personal information is filled into registration information on a registration page. This reduces the amount of information to be input during a registration process, and improves registration efficiency. In addition, the registration information comes from the third-party website having high credibility, thereby improving reliability of the registration information.

Referring to FIG. 7, this embodiment provides a system for login. The system includes a server 500 of a source website and a server 600 of a third-party website.

The server 500 of the source website includes: a first outputting module, configured to provide a login page having a verification link of the third-party website.

The server 600 of the third-party website includes: a second outputting module, configured to output a login page of the third-party website upon receiving from a user a trigger of the verification link of the third-party website output by the first outputting module.

The server 600 of the third-party website further includes: a verifying module, configured to receive login information input by a user on the third-party website, and verify the login information.

The server 600 of the third-party website further includes: a returning module, configured to return personal information of the user to the server of the source website when the login information is successfully verified by the server of the third-party website.

The server 500 of the source website further includes: a login module, configured to acquire the personal information of the user, and complete login according to the personal information of the user.

Furthermore, the server of the source website includes: a judging module, configured to: prior to login, judging whether the user is a registered user of the source website; if the user is a registered user of the source website, generate a session key, display login status, and complete login; and otherwise, perform a subsequent step.

Furthermore, the judging module includes:

a judging unit, configured to: judge whether a user name of the registered user comprises an email address of the user; if true, determine that the user is a registered user of the source website; and otherwise, determine that the user is not a registered user of the source website.

In this embodiment, the third-party website includes an open platform website providing an API for other websites.

The system provided in this embodiment is based on the same inventive concept as the source website in method embodiment. Therefore, the detailed implementation can refer to the description of the method embodiments of the present disclosure, which is not described herein any further.

According to this embodiment, during website login, authorized personal information of a user is acquired over a third-party website, and whether the user is a user of a source website is judged according to the acquired personal information. If the user is a user of a source website, a session key is generated, login status is displayed, and the user does not need to remember a plurality of passwords. In addition, if a non-registered user is found, registration can be performed according to a simplified registration process, a session key is generated again, and login status is displayed. This saves registration time for the user, and the user does not need to memorize a plurality of passwords.

It should be noted that the modules described in the embodiments illustrating the system for registration or login are divided only according to the function logic but are not limited thereto. Modules that can implements corresponding functions are also applicable.

In addition, names of the functional modules are for differentiation purpose only, and therefore are not intended to limit the protection scope of the present disclosure.

A person skilled in the art should understand that all or part of steps of the preceding methods may be implemented by hardware or hardware following instructions of programs. The programs may be stored in a computer readable storage medium. The storage medium may be a read only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. A method for registration, comprising:
providing, by a server of a source website, a registration page having a verification link of a third-party website;
upon receiving a trigger of the verification link of the third-party website, outputting, by a server of the third-party website, a login page of the third-party website;
receiving, by the server of the third-party website, login information input by a user on the third-party website, and verifying the login information;
when the login information is successfully verified by the server of the third-party website, returning, by the server of the third-party website, personal information of the user to the server of the source website; and
acquiring, by the server of the source website, the personal information of the user, and correspondingly filling the personal information into registration information on the registration page of the source website.

2. The method according to claim 1, wherein the returning, by the server of the third-party website, personal information of the user to the server of the source website comprises:
outputting, by the server of the third-party website, the personal information input by the user on the third-party website for the user to select;
receiving, by the server of the third-party website, the personal information selected by the user that is authorized to the server of the source website; and
returning, by the server of the third-party website, the personal information selected by the user that is authorized to the server of the source website to the server of the source website.

3. The method according to claim 2, wherein the receiving, by the server of the third-party website, the personal information selected by the user for the server of the source website to use comprises:
outputting, by the server of the third-party website, an authorization page, and options “Allow source website to use” and “Not allow source website to use” corresponding to each piece of the personal information for the user to select, wherein the authorization page comprises the personal information input by the user on the third-party website.

4. The method according to claim 1, wherein after the correspondingly filling, by the server of the source website, the personal information into registration information on the registration page of the source website, the method further comprises:
randomly generating, by the server of the source website, a password as an initial password for the user to log in to the source website; or using, by the server of the source website, a password input by the user as an initial password for the user to log in to the source website.

5. The method according to claim 1, wherein the third-party website comprises an open platform website providing an application programming interface (API) for other websites.

6. The method according to claim 1, wherein the registration page having a verification link of a third-party website comprises a basic option of a registration process.

7. A method for login, comprising:
providing, by a server of a source website, a login page having a verification link of a third-party website;
upon receiving a trigger of the verification link of the third-party website from a user, outputting, by a server of the third-party website, a login page of the third-party website;
receiving, by the server of the third-party website, login information input by a user on the third-party website, and verifying the login information;
when the login information is successfully verified by the server of the third-party website, returning personal, by the server of the third-party website, information of the user to the server of the source website; and
completing login by the server of the source website according to the received personal information of the user.

8. The method according to claim 7, wherein prior to performing the steps, the method further comprises:
judging, by the server of the source website according to the personal information of the user, whether the user is a registered user of the source website;
if the user is a registered user of the source website, generating, by the server of the source website, a session key, displaying login status, and completing login;
otherwise, performing a subsequent step.

9. The method according to claim 8, wherein the judging, by the server of the source website according to the personal information of the user, whether the user is a registered user of the source website comprises:
judging, by the server of the source website, whether a user name of the registered user comprises an email address of the user; if true, determining, by the server of the source website, that the user is a registered user of the source website; and otherwise, determining, by the server of the source website, that the user is not a registered user of the source website.

10. The method according to claim 7, wherein the third-party website comprises an open platform website providing an application programming interface (API) for other websites.

11. A system for registration, comprising: a server of a source website and a server of a third-party website; wherein
the server of the source website comprises: a first outputting module, configured to provide a registration page having a verification link of the third-party website;
the server of the third-party website comprises: a second outputting module, configured to output a login page of the third-party website when the server of the third-party website receives from a user a trigger of the verification link of the third-party website output by the first outputting module;
the server of the third-party website further comprises: a verifying module, configured to receive login information input by a user on the third-party website, and verify the login information;
the server of the third-party website further comprises: a returning module, configured to return personal information of the user to the server of the source website when the login information is successfully verified by the server of the third-party website; and
the server of the source website further comprises: a registering module, configured to acquire the personal information of the user, and correspondingly fill the personal information into registration information on the registration page of the source website.

12. The system according to claim 11, wherein the returning module comprises:
an outputting unit, configured to output the personal information input by the user on the third-party website for the user to select;
a receiving unit, configured to receive the personal information selected by the user that is authorized to the server of the source website; and
a returning unit, configured to return the personal information selected by the user that is authorized to the server of the source website to the server of the source website.

13. The system according to claim 12, wherein the outputting unit is specifically configured to:
output an authorization page, and options “Allow source website to use” and “Not allow source website to use” corresponding to each piece of the personal information for the user to select, wherein the authorization page comprises the personal information input by the user on the third-party website.

14. The system according to claim 11, wherein the server of the source website further comprises:
a password generating module, configured to: after the server of the source website correspondingly fills the personal information into registration information on the registration page of the source website, randomly generate a password as an initial password for the user to log in to the source website; or use a password input by the user as an initial password for the user to log in to the source website.

15. The system according to claim 11, wherein the third-party website comprises an open platform website providing an application programming interface (API) for other websites.

16. The system according to claim 11, wherein the registration page having a verification link of a third-party website comprises a basic option of a registration process.

17. A system for login, comprising: a server of a source website and a server of a third-party website; wherein
the server of the source website comprises: a first outputting module, configured to provide a login page having a verification link of the third-party website;
the server of the third-party website comprises: a second outputting module, configured to output a login page of the third-party website upon receiving from a user a trigger of the verification link of the third-party website output by the first outputting module;
the server of the third-party website further comprises: a verifying module, configured to receive login information input by a user on the third-party website, and verify the login information;
the server of the third-party website further comprises: a returning module, configured to return personal information of the user to the server of the source website when the login information is successfully verified by the server of the third-party website; and
the server of the source website further comprises: a login module, configured to acquire the personal information of the user, and complete login according to the personal information of the user.

18. The system according to claim 17, wherein
the server of the source website comprises: a judging module, configured to: prior to login, judging whether the user is a registered user of the source website; if the user is a registered user of the source website, generate a session key, display login status, and complete login; and otherwise, perform a subsequent step.

19. The system according to claim 18, wherein the judging module comprises:
a judging unit, configured to: judge whether a user name of the registered user comprises an email address of the user; if true, determine that the user is a registered user of the source website; and otherwise, determine that the user is not a registered user of the source website.

20. The system according to claim 17, wherein the third-party website comprises an open platform website providing an application programming interface (API) for other websites.
